(19) United States
(12) Patent Application Publication
(10) Pub. No.: US 2026/0211239 A1
(43) Pub. Date: Jul. 23, 2026

(54) BINOCULAR ALIGNMENT OF VIRTUAL IMAGE DISPLAYS

(71) Applicant: Vuzix Corporation, West Henrietta, NY (US)

(72) Inventors: Tyler W. Porter, Honeoye Falls, NY (US); Brent Keller, Rochester, NY (US); Jeff Lange, Ionia, NY (US)

(21) Appl. No.: 19/144,464

(22) PCT Filed: Dec. 22, 2023
(86) PCT No.: PCT/US2023/085834

§ 371 Date: Jun. 28, 2025

Related U.S. Application Data
(60) Provisional application No. 63/435,783, filed on Dec. 28, 2022.

(51) Int. Cl. G02B 27/01; H04N 13/327; H04N 13/344; H04N 13/398

(52) U.S. Cl. CPC G02B 27/0172; H04N 13/327; H04N 13/344; H04N 13/398; G02B 2027/0134; G02B 27/0176; G02B 2027/0178

(57) ABSTRACT

A binocular augmented-reality display system, including a frame, a first image light guide and a second image light guide supported by the frame, a first image source system arranged within the frame, the first image source system including a first display panel having a first plurality of light sources, and a second image source system arranged within the frame, the second image source system including a second display panel having a second plurality of light sources. At least one processor and at least one non-transitory computer-readable memory, are configured to generate, via the first display engine, a first image using a first subset of the first plurality of light sources, receive a first input signal and, in response to the first input signal, generate a second image using a second subset of the first plurality of light sources, and generate, via the second display engine, a third image using a first subset of the second plurality of light sources.

### TECHNICAL FIELD

This disclosure generally relates to electronic displays worn by a viewer for forming virtual images, and more particularly relates to binocular alignment of images in Head-Mounted Displays (HMDs).

### BACKGROUND

HMDs are being developed for a range of diverse uses, including military, commercial, industrial, firefighting, and entertainment applications. For many of these applications, there is particular value in forming a virtual image that can be visually superimposed over the real-world image formed in the eye from within the field of view of the HMD user. An image light guide may convey image-bearing light to a viewer for directing the virtual image to the viewer's pupil and enabling this superposition function.

Image light guides and, for example, diffractive optical elements, may form a virtual image focused at optical infinity by conveying angularly encoded light beams of collimated light to the viewer eyebox. However, a virtual image may be focused at a finite distance, such as in the range from 1 m to 1.5 m, for example. Using near-focused solutions can allow the viewer to have the advantage of augmented reality imaging in applications where it is useful to have the real-world scene content at a close distance, such as manufacturing and warehousing applications, for example.

A binocular HMD may include a projector system having, for example, a projector and image light guide for the left eye and a projector and image light guide for the right eye. An initial calibration and alignment of the projectors may be set during production and/or assembly; however, variations in human anatomy, such as facial geometry and positioning of the eyes (i.e., inter-pupillary distance) as well as mechanical changes to the frame of the HUD may cause the images produced to be out of alignment for a user. Misalignment may result in eye strain or the perception of double-images. Double-images occur when the content conveyed to the left and right eyes does not converge in the viewer's mind as a single object in space, and instead the content is perceived as two individual objects in space. Therefore, there is a need for binocular image calibration and alignment after a user has received a binocular HMD. Projector alignment can also be used to change binocular vergence that may induce the sensation of a change in focal depth of at least a portion of the three-dimensional (3D) images produced.

### SUMMARY

The present disclosure provides a system and method for producing properly aligned stereoscopic presentation of virtual images in a near-eye display system via calibration and alignment implemented at a hardware-command level. In some examples, this alignment or calibration takes place at a point in time after the initial factory-calibration of such a system. Reducing or eliminating virtual image misalignment and undesirable optical effects such as incorrect coloration, blurring, and optical noise may mitigate, for example, double-images and eye strain (i.e., asthenopia). Thus, the present disclosure is directed to, inter alia, systems and methods of calibrating and/or altering the alignment of the image(s) generated by one or more of the projectors using the display projector and a graphical user interface (GUI) presented to the user on the HUD device to customize the projector/image alignment.

In a first exemplary embodiment, the present disclosure provides a system for alignment of virtual images in a binocular augmented reality display system, including a frame, a first image light guide and a second image light guide supported by the frame, a first image source system arranged within the frame, the first image source system including a first display panel having a first plurality of light sources, and a second image source system arranged within the frame, the second image source system including a second display panel having a second plurality of light sources. At least one processor and at least one non-transitory computer-readable memory, wherein the processor and memory are arranged to execute and store, respectively, a set of non-transitory computer-readable instructions, that when executed by the processor are configured to generate, via the first image source system, a first image using a first subset of the first plurality of light sources, receive a first input signal and, in response to the first input signal, generate a second image using a second subset of the first plurality of light sources, and generate, via the image source system, a third image using a first subset of the second plurality of light sources. Wherein the images generated by the first image source system are conveyed by the first image light guide to a first eyebox, and the images generated by the second image source system are conveyed by the second image light guide to a second eyebox, wherein the second image is stereoscopically aligned with the third image.

### BRIEF DESCRIPTION OF THE DRAWING FIGURES

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 is a simplified cross-sectional view of an image light guide showing the replication of an image-bearing beam along the direction of propagation for expanding one dimension of an eyebox according to an exemplary embodiment of the presently disclosed subject matter.

FIG. 2A is a schematic perspective view of a binocular HMD operable to form a stereoscopic virtual image for a viewer according to an exemplary embodiment of the presently disclosed subject matter.

FIG. 2B is a schematic perspective view of a binocular HMD according to FIG. 2A, in which there is vertical misalignment between the left-eye and right-eye virtual images.

FIG. 3 is a left-side view of the binocular HMD according to FIG. 2B.

FIG. 4A is a schematic view of a stereoscopic virtual image comprising substantially aligned wireframe text.

FIG. 4B is a schematic view of a stereoscopic virtual image comprising misaligned wireframe text.

FIG. 5A is a schematic perspective view of an image source system according to an exemplary embodiment of the presently disclosed subject matter.

FIG. 5B is a cross-sectional view of a portion of the image source system according to FIG. 5A.

FIG. 6A is a schematic view of a portion of the image source system according to FIG. 5A.

FIG. 6B is a schematic view of a portion of the image source system according to FIG. 5A.

FIGS. 7A-7D show a graphical user interface for calibration of stereoscopic images according to an exemplary embodiment of the presently disclosed subject matter.

FIG. 8 is a schematic perspective view of a binocular HMD operable to form a stereoscopic virtual image for a viewer according to an exemplary embodiment of the presently disclosed subject matter.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

One skilled in the relevant art will recognize that the elements and techniques described herein can be practiced without one or more of the specific details, or with other methods, components, materials, etc. In some instances, well-known structures, materials, or operations are not shown or described in detail to avoid obscuring certain aspects of the present disclosure. Reference throughout the specification to “one embodiment” or “an embodiment” means that a particular feature, structure, or characteristic described in connection with the embodiment is included in at least one embodiment of the present disclosure. Thus, the appearance of the phrase “in one embodiment” or “in an embodiment” throughout the specification is not necessarily referring to the same embodiment. However, the particular features, structures, or characteristics described may be combined in any suitable manner in one or more embodiments.

Where used herein, the terms “first”, “second”, and so on, do not necessarily denote any ordinal, sequential, or priority relation, but are simply used to more clearly distinguish one element or set of elements from another, unless specified otherwise.

Where used herein, the terms “viewer”, “operator”, “observer”, and “user” are considered to be equivalent and refer to the person, or machine, who wears and/or views images using a near-eye display device.

Where used herein, the terms “coupled” or “coupler” (in the context of optics) refer to a connection by which light travels from one optical medium or device to another optical medium or device.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

Where used herein, the term “substantially” is intended to mean within the tolerance range of the equipment used to produce the value, or, in some examples, is intended to mean plus or minus 10%, or plus or minus 5%, or plus or minus 1%, unless otherwise expressly specified.

Where used herein, the terms “optical infinity” and “at infinity” correspond to conventional usage in the camera and imaging arts, indicating image formation using substantially collimated light, so that the focus distance exceeds at least about four meters (4 m).

Where used herein, the term “beam expansion” is intended to mean replication of a beam via multiple encounters with an optical element to provide exit pupil expansion in one or more directions. Similarly, as used herein, to “expand” a beam, or a portion of a beam, is intended to mean replication of a beam via multiple encounters with an optical element to provide exit pupil expansion in one or more directions.

An optical system, such as a HMD, can produce a virtual image display. In contrast to methods for forming a real image, a virtual image is not formed on a display surface. That is, if a display surface were positioned at the perceived location of a virtual image, no image would be formed on that surface. Virtual image display has a number of inherent advantages for augmented reality presentation. For example, the apparent size of a virtual image is not limited by the size or location of a display surface. Additionally, the source object for a virtual image may be small; for example, a magnifying glass provides a virtual image of an object. In comparison with systems that project a real image, a more realistic viewing experience can be provided by forming a virtual image that appears to be some distance away. Providing a virtual image also obviates the need to compensate for screen artifacts, as may be necessary when projecting a real image.

An image light guide may utilize image-bearing light from a light source such as a projector to display a virtual image. For example, collimated, relatively angularly encoded, light beams from a projector are coupled into a planar waveguide by an input coupling such as an in-coupling diffractive optic, which can be mounted or formed on a surface of the planar waveguide or buried within the waveguide. Such diffractive optics can be formed as diffraction gratings, holographic optical elements (HOEs) or in other known ways. For example, the diffraction grating can be formed by surface relief. After propagating along the waveguide, the diffracted light can be directed back out of the waveguide by a similar output coupling such as an out-coupling diffractive optic, which can be arranged to provide pupil expansion along at least one direction of the virtual image. In addition, a turning grating can be positioned on/in the waveguide to provide pupil expansion in an orthogonal direction of the virtual image. The image-bearing light output from the waveguide provides an expanded eyebox for the viewer.

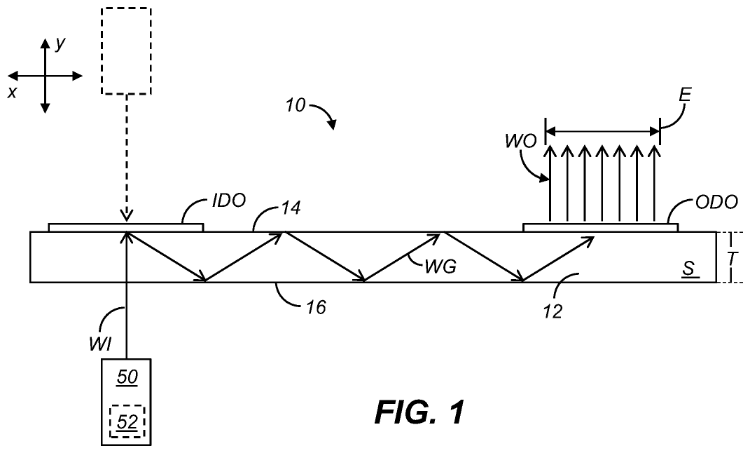

FIG. 1 is a schematic diagram showing a simplified cross-sectional view of one conventional configuration of an image light guide system 10. Image light guide system 10 includes a planar image light guide 12, an in-coupling diffractive optic IDO, and an out-coupling diffractive optic ODO. The image light guide 12 includes a transparent substrate S, which can be made of optical glass or plastic, with plane-parallel front and back surfaces 14, 16. In this example, the in-coupling diffractive optic IDO is shown as a transmissive-type diffraction grating arranged on, in, or otherwise engaged with the front surface 14 of the image light guide 12. However, in-coupling diffractive optic IDO could alternately be a reflective-type diffraction grating or other type of diffractive optic, such as a volume hologram or other holographic diffraction element, that diffracts incoming image-bearing light beams WI into the image light guide 12. The in-coupling diffractive optic IDO can be located on, in, or otherwise engaged with front surface 14 or back surface 16 of the image light guide 12 and can be of a transmissive or reflective-type in a combination that depends upon the direction from which the image-bearing light beams WI approach the image light guide 12.

When used as a part of a near-eye or HMD, the in-coupling diffractive optic IDO of the conventional image light guide system 10 couples the image-bearing light beams WI from an image source system 50 into the substrate S of the image light guide 12. Any real image or image dimension formed by the image source system 50 is first converted into an array of overlapping, angularly related, collimated beams encoding the different positions within a virtual image for presentation to the in-coupling diffractive optic IDO. Typically, the rays within each bundle forming one of the angularly related beams extend in parallel, but the angularly related beams are relatively inclined to each other through angles that can be defined in two angular dimensions corresponding to linear dimensions of the image.

Once the angularly related beams engage with the in-coupling diffractive optic IDO, at least a portion of the image-bearing light beams WI are diffracted (generally through a first diffraction order) and thereby redirected by in-coupling diffractive optic IDO into the planar image light guide 12 as angularly encoded image-bearing light beams WG for further propagation along a length dimension x of the image light guide 12 by total internal reflection (TIR) between the plane-parallel front and back surfaces 14 and 16. Although diffracted into a different combination of angularly related beams in keeping with the boundaries set by TIR, the image-bearing light beams WG preserve the image information in an angularly encoded form that is derivable from the parameters of the in-coupling diffractive optic IDO. The out-coupling diffractive optic ODO receives the encoded image-bearing light beams WG and diffracts (also generally through a first diffraction order) at least a portion of the image-bearing light beams WG out of the image light guide 12, as image-bearing light beams WO, toward a nearby region of space referred to as an eyebox E, within which the transmitted virtual image can be seen by a viewer's eye or other optical component. The out-coupling diffractive optic ODO can be designed symmetrically with respect to the in-coupling diffractive optic IDO to restore the original angular relationships of the image-bearing light beams WI among outputted angularly related beams of the image-bearing light beams WO. In addition, in an example embodiment, the out-coupling diffractive optic ODO can modify the original field points' positional angular relationships producing an output virtual image at a finite focusing distance.

However, to increase one dimension of overlap among the angularly related beams populating the eyebox E (defining the size of the region within which the virtual image can be seen), the out-coupling diffractive optic ODO is arranged together with a limited thickness T of the image light guide 12 to encounter the image-bearing light beams WG multiple times and to diffract only a portion of the image-bearing light beams WG upon each encounter. The multiple encounters along the length (e.g., a first direction) of the out-coupling diffractive optic ODO have the effect of replicating the image-bearing light beams WG and enlarging or expanding at least one dimension of the eyebox E where the replicated beams overlap. The expanded eyebox E decreases sensitivity to the position of a viewer's eye 5 for viewing the virtual image.

The out-coupling diffractive optic ODO is shown as a transmissive-type diffraction grating arranged on or secured to the front surface 14 of the image light guide 12. However, like the in-coupling diffractive optic IDO, the out-coupling diffractive optic ODO can be located on, in, or otherwise engaged with the front or back surface 14, 16 of the image light guide 12 and can be of a transmissive or reflective-type in a combination that depends upon the direction through which the image-bearing light beams WG is intended to exit the image light guide 12. In addition, the out-coupling diffractive optic ODO could be formed as another type of diffractive optic, such as a volume hologram or other holographic diffraction element, that diffracts propagating image-bearing light beams WG from the image light guide 12 as the image-bearing light beams WO propagating toward the eyebox E.

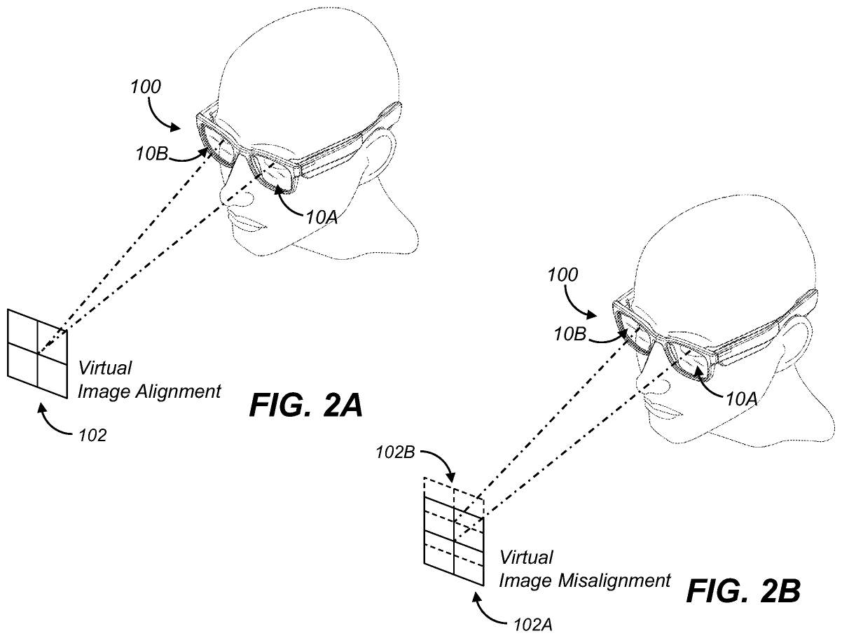

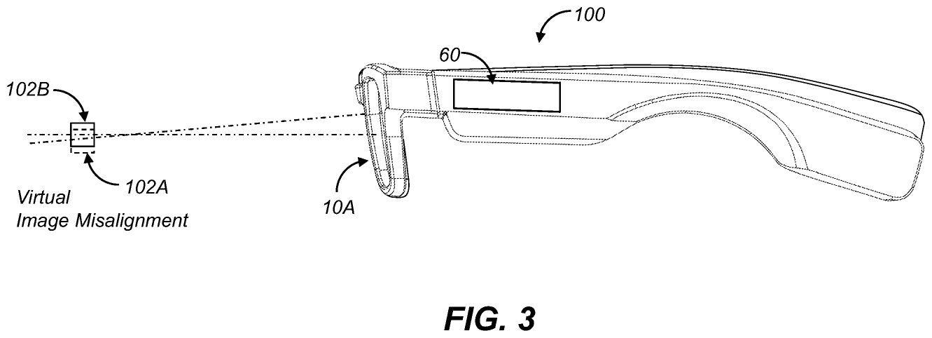

FIGS. 2A, 2B, and 3 show a HMD 100 operable to form a stereoscopic virtual image 102 for a viewer. HMD 100 is configured to form a left-eye virtual image 102A and a right-eye virtual image 102B aligned with each other at a distance in front of the HMD 100 to provide the advantages of stereoscopic image presentation. In FIG. 2A, left-eye image 102A and right-eye image 102B are shown in alignment for stereoscopic imaging. In FIGS. 2B and 3, left-eye image 102A and right-eye image 102B are shown in misalignment (e.g., exaggerated vertical misalignment). In an example embodiment, the HMD 100 includes a first image light guide system 10A and a second image light guide system 10B. The first image light guide system 10A is configured to convey image-bearing light to a user's left eye and the second image light guide system 10B is configured to convey image-bearing light to a user's right eye. For example, the first image light guide system 10A and the second image light guide system 10B can include one or more image light guides, e.g., an optical waveguide, having one or more regions comprising diffractive optics, e.g., surface relief gratings, a holographic optical element (HOE), or liquid crystal material designed to diffract, in-couple, turn, or out-couple image-bearing light generated by a respective image source system 50 (shown in FIG. 1).

The HMD 100 is generally adjustable to be comfortably and effectively worn by viewers with different head sizes or with other anatomical variations, including, without limitation, variations in interpupillary distance, that affect the way in which the displays of the HMD 100 are mounted on the viewers' heads. Embodiments of the present disclosure can accommodate the reshaping of HMD 100 for fitting different viewer head anatomies while preserving the desired stereoscopic presentation to each viewer. Although the HMD 100 is illustrated as a “smart glasses” system, it should be appreciated that the present disclosure applies equally to Heads-Up Displays (HUDs) with different positioning of the image light guides 10A, 10B, image source systems 50, associated drive electronics, memory, and processor. For example, without limitation, the HMD 100 may be configured to resemble and/or be integrated with eyeglasses, ski goggles, swim goggles, and a helmet.

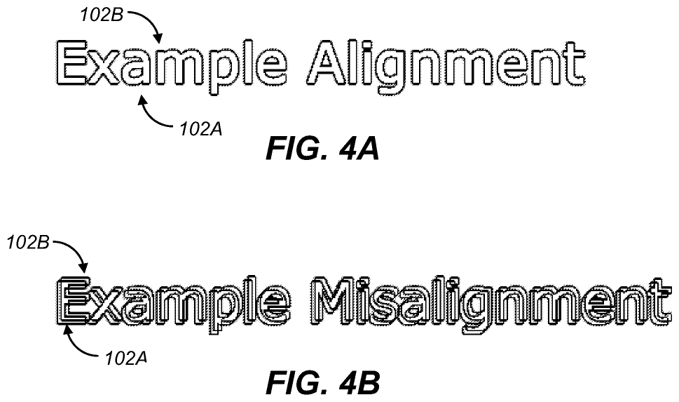

In an example embodiment, an initial calibration and alignment of left and right the image source systems 50 is performed during production and/or assembly of the HMD 100. Referring now to FIGS. 4A and 4B, variations in human anatomy, such as facial geometry and positioning of the eyes (i.e., inter-pupillary distance) as well as mechanical changes to the frame of the HMD 100 may cause the images 102A, 102B conveyed to the eyeboxes E to be out of alignment for stereoscopic viewing. FIG. 4B shows an example of misalignment resulting in the perception of double-images. For example, the images 102A, 102B shown in FIGS. 4A and 4B simulate substantially identical wireframe text generated by two image source systems 50. As illustrated in FIG. 4A, if the resulting images 102A, 102B are aligned properly, the user will perceive a single object (e.g., image 102) seen by both eyes. As illustrated in FIG. 4B, if the resulting images 102A, 102B are misaligned (horizontally, vertically or via a combination of both), the user will perceive two independent objects (e.g., images 102A, 102B) that are in a conflicting space with one another.

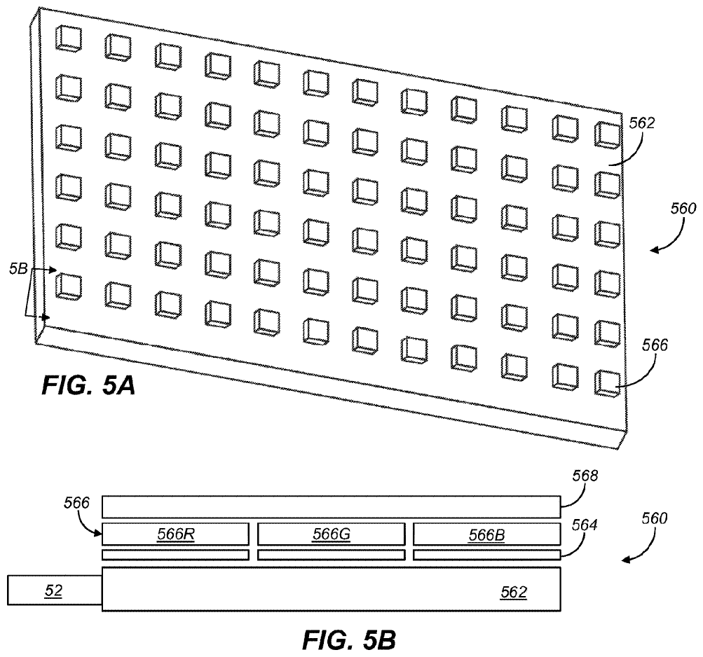

As illustrated in FIGS. 5A and 5B, in an example embodiment, the image source system 50 is a self-emitting microLED display projector that includes a self-emitting microLED display panel 560. For example, as shown in FIG. 5B, which illustrates a cross-sectional view of a portion of the self-emitting microLED display panel 560 schematically shown in FIG. 5A, the self-emitting microLED display panel 560 includes a substrate 562, an electrode layer 564 a microLED/OLED array 566, and a front layer 568. Each microLED 566R, 566G, 566B is an individually addressable component of the self-emitting microLED display panel 560. Each microLED 566R, 566G, 566B corresponds to at least a portion of one or more pixels in a projected image. In an example embodiment, the microLED array 566 is configured to emit light as a function of power applied to each self-emitting light source. For example, the microLED array 566 can roughly approximate the size and shape of the in-coupling diffractive optic IDO of an associated image light guide system 10A, 10B.

In an example embodiment, the image source systems 50 have more usable microLEDs 566 arranged on substrate 562 than are typically used to create an image 102. For example, should the image source systems 50 be designed to create and/or display an image that is 640×480 resolution, the image source systems 50 may have an array of 664×500 microLEDs 566. It should be appreciated that 640×480 resolution is merely one example display resolution and that other display resolutions, e.g., 1024×768 or 1920×1080, are possible. Therefore, during the generation of any given image there is a subset 570 of microLEDs 566 used to create image 102, and a subset 572 of microLEDs 566 that are not used to create image 102.

The virtual images 102 output from the HMD 100 comprise overlapping image-bearing light beams within which the virtual images 102 are angularly encoded. The image-bearing light beams corresponding to matching points within the left-eye and right-eye images 102A, 102B are aligned with each other or otherwise converge toward common points in the space in front of the HMD 100 to support the desired stereoscopic presentation. Thus, the HMD 100 is configured to maintain the desired angular relationships between the left-eye and right-eye images 102A, 102B.

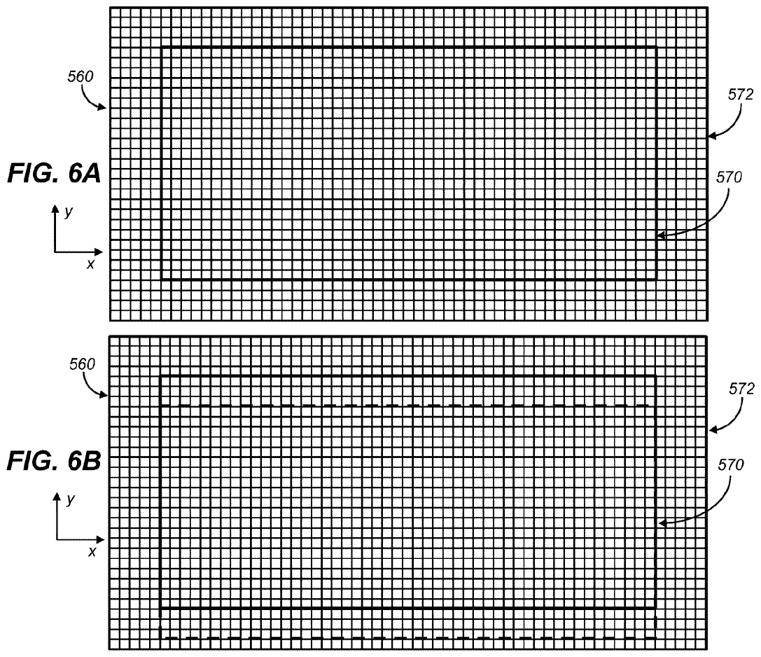

The comparatively greater number of microLEDs 566 in the microLED array 560 than pixels utilized to generate images 102 provides a margin of unused microLEDs 566 in the subset 572. For example, using the exemplary resolution and configuration described above, when generating a 640×480 image with a display that includes 664×500 microLEDs 566, and assuming the image created is centered within the array of microLEDs 566, there is a margin of twelve unused microLEDs 566 to the left and right of the subset 570 and a margin of ten unused microLEDs 566 above and below the subset 570. In an example embodiment, the subset 570 of microLEDs 566 can be moved within the microLED array 560 and at least partially into the margin area of initially unused microLEDs 566 to alter the angular relationship of the image-bearing light conveyed through the image light guide systems 10A, 10B and change the alignment of the images 102A, 102B conveyed to the eyeboxes E and viewed by the user. Referring now to FIGS. 6A and 6B, for example, the subset 570 of microLEDs 566 utilized to generate an image 102 may be shifted down on the microLED array 560. As illustrated in FIG. 6B, the subset 570 of microLEDs 566 may be moved in the (−) y-axis direction by three microLEDs 566 to calibrate alignment of an image 102.

In other words, shifting the microLEDs 566 energized by the right and/or left image source systems 50 to alter the angular relationship of the images 102A, 102B conveyed through the image light guide systems 10A, 10B can be utilized to align the two images 102A, 102B in a way that suits the user. It should be appreciated that the number of horizontal and vertical pixels shown in FIGS. 6A-6B are not to be construed to be limiting in any way and that, as described above, other pixel configurations are possible.

In an example embodiment, the shifting of the microLEDs 566 energized by an image source system 50 happens at the hardware level rather than purely at the software level. For example, in some exemplary embodiments, the image source systems 50 comprise an on-board chip 52 that receives command signals from a processor of the HMD 100 when the user re-aligns the image 102 through the graphical user interface (GUI) provided. Once that alignment step is performed and the commands are sent to the on-board chip 52 set on the respective right and left image source systems 50, the microLED arrays 560 only use the newly selected subset 570 to generate the image 102. The alignment step may be performed any number of times utilizing the GUI to allow for multiple users of the HMD 100 and/or deformation of the HMD 100. It should be appreciated that the on-board chip 52 utilized by the respective image source systems 50 can include a discrete processor and non-transitory, computer-readable, and non-volatile memory configured to execute and store respectively a set of instructions related to the configuration of used and unused microLEDs 566 within the arrays 560.

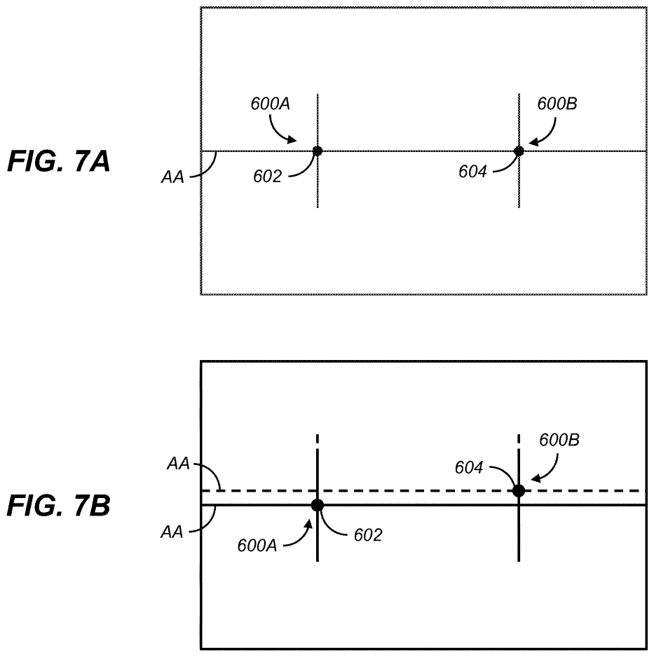

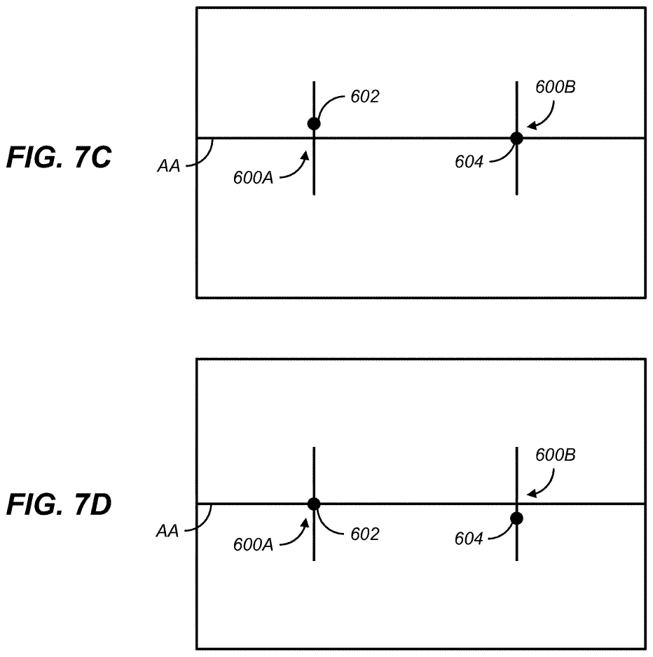

In an example embodiment, the HMD 100 includes a processor and non-transitory computer-readable memory configured to execute and store a set of computer-readable instructions that when executed by the processor are configured to operate the HMD 100. The processor also includes a software suite configured to enable a user to recalibrate alignment of the images 102A, 102B at the hardware level. When a user finds that the image 102 is not aligned (e.g., is presented as a double image or the user is experiencing noticeable eye-strain), the user may access a portion of the software suite provided to adjust alignment of the images 102A, 102B. In an example embodiment, the software suite includes the GUI shown in FIGS. 7A-7D. FIG. 7A shows a left-eye reticle 600A within image 102A and a right-eye reticle 600B within image 102B, where the reticles 600A and 600B are in vertical alignment along an imaginary horizontal axis AA. An alignment point 602 is associated with the position of the left-eye image 102A and an alignment point 604 is associated with the position of the right-eye image 102B.

As shown in FIG. 7B, in an example embodiment, when the images 102A, 102B are vertically misaligned, the user will perceive a double image of the reticles 600A, 600B within the GUI. Using an input device 160, such as a touch-sensitive pad located on a temple of one or more temple arms of the HMD 100, or an external device wirelessly connected to the HMD 100 (e.g., a smart phone, tablet, personal computer, etc.) the user can, via the user input device 160, incrementally shift the position of the alignment points 602, 604 relative to the left-eye reticle 600A and the right-eye reticle 600B. For example, as shown in FIG. 7C, the user may incrementally shift the alignment point 602 up, relative to the alignment point 604. Similarly, as shown in FIG. 7D, the user may incrementally shift the alignment point 604 down, relative to the alignment point 602. It should be appreciated that the position of both alignment points 602, 604 may be adjusted simultaneously or independently. By relatively shifting the alignment points 602, 604, the images 102A, 102B can be aligned for stereoscopic viewing. The left-eye reticle 600A and the right-eye reticle 600B provide a visual indicator for the amount of adjustment to the left and right images 102A, 102B. In one example embodiment, the user input is provided by a touch sensitive pad or slide 60, that creates an equal and opposite adjustment between the left and right reticles 600A, 600B. For example, as the user drags their finger across a touch-sensitive pad, the alignment point 602 will be shifted down by some magnitude while the alignment point 604 simultaneously is shifted up at an equal magnitude. It should also be appreciated that, although the exemplary embodiments illustrated and described herein, provide for a mechanism to make alignment adjustments based on vertical misalignment between the left and right-eye images, similar adjustments can be made to alter the vergence of images in the horizontal direction.

By visually shifting the position of the alignment point 602, 604 within the GUI as described above, the software suite will instruct, by sending one or more commands, the on-board chip 52 of the respective image source system 50 to shift the usable subset 570 of microLEDs 566 up or down as a function of the movement of the alignment point 602, 604. Once the software suite GUI has instructed the on-board chip 52 of the respective image source system 50 to change the usable subset 570 of microLEDs 566, the usable subset 570 of microLEDs 566 will be maintained until alignment is recalibrated via the software suite GUI. Advantageously, in an example embodiment, the present disclosure provides for alignment of virtual images 102A, 102B at a hardware level, and does not require continuous calculation of pixel position by the operating system (e.g., reducing processing to determine pixel orbit). Additionally, via the hardware level alignment described above, the HMD 100 utilizes less power than systems utilizing conventional alignment mechanisms because only the usable subset 570 of microLEDs 566 are energizable.

In one example operation, the user of the HMD 100 places the HMD 100 on their head/face. The respective left and right image source systems 50 are arranged to create respective first images and relay those respective first images to the user's eyes via the left and right image light guides 10A, 10B. Should the user experience eye-strain and/or perceive double-images formed by the virtual images caused by misalignment of the virtual images displayed, the user can utilize the GUI provided within the software suite of the HMD 100 to make incremental adjustments to the usable and non-usable portions of the microLED array 560. For example, the user may shift the usable subset of microLEDs 566 for either the left or right image source systems 50 up, down, left, and/or right until the eye strain and/or double images is remedied. Every incremental change provided by the user, via a user input 160, causes the processor of the HMD 100 to send one or more command signals to the on-board chip 52 of the left and/or right image source system's 50 on-board chip 52. The command signals operate to make a corresponding change in the drivable or usable area of microLEDs 566 within the array 560 and are stored at a hardware and/or firmware level. Thus, after the commands have been received, one or more new images are created by the left and right image source systems 50 that utilize a new combination of microLEDs 566 from the array 560. It should be appreciated that the new images can utilize one or more microLEDs 566 that were previously designated as unused. As the change to usable area of the array 560 is stored and effected at a hardware and/or firmware level, the image processing requirements of the HMD 100 do not change as the usable area is shifted. This is unlike current alignment software in that any change made to the position of an image within an HMD 100 is accomplished via additional software commands requiring an adjustment to every frame presented to the user. The additional time/processing resources to constantly adjust every subsequent frame can add up to a significant addition to the power and/or processing budget. The present systems and methods avoid that additional processing requirement and therefore save power and processing power over conventional systems.

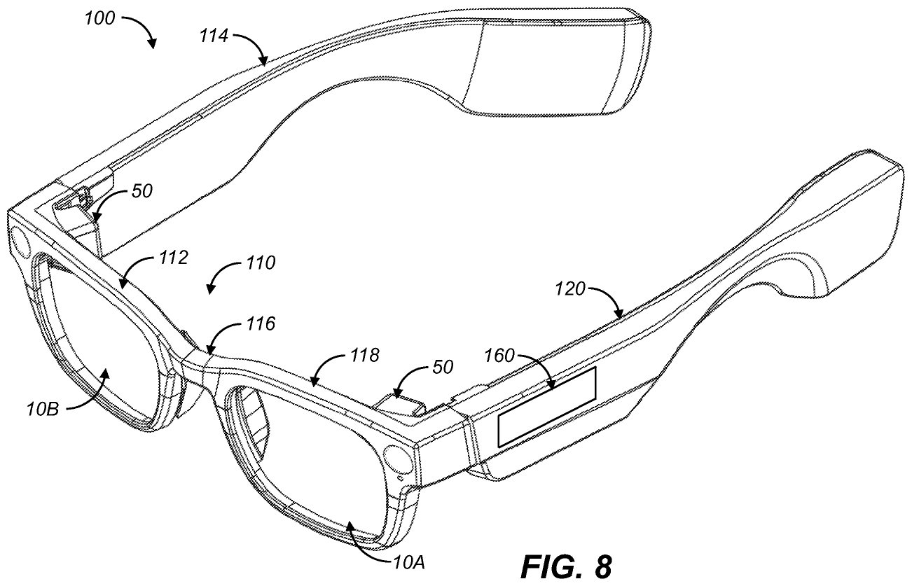

Referring now to FIG. 8, in an example embodiment, HMD 100 includes a frame 110 which includes a right eye-rim section 112, a right temple 114, and a nose-bridge portion 116. Between temple 114 and nose-bridge portion 116, frame 110 includes a right aperture configured to receive image light guide 10B operable to form at least one image related to one or more virtual objects within a viewer's right eye. Frame 110 also includes a left eye-rim section 118 connected with the nose-bridge portion 116, and a left temple 120. Between temple 120 and nose-bridge portion 116, frame 110 includes a left aperture configured to receive image light guide 10A operable to form at least one image related to one or more virtual objects within a viewer's left eye.

As described above, HMD 100 can be configured as a binocular display system forming images in both the right and left eye of the viewer. In some examples, frame 110 is made of a metal, plastic, or wood material (or any combination thereof), and is intended to be opaque, i.e., not transmissive to visible light. In some examples, image light guides 10A, 10B are removably secured between the temple 114, 120 and the nose-bridge portion 116, i.e., image light guides 10A, 10B can be removed and/or replaced without the aid of additional tools. Further, it should be appreciated that in one or more exemplary embodiments, HMD 100 can include multiple, stacked, image light guides 10A, 10B. For example, one image light guide 10 of the stack is configured to in-couple and propagate light of a first wavelength range (e.g., light in the red portion of the visible spectrum), while another image light guide 10 of the stack is configured to in-couple and propagate a second wavelength range (e.g., light in the green and/or blue portions of the visible spectrum).

In an example embodiment, the nose-bridge portion 116 is at least partially flexible, and/or semi-rigid, to facilitate a comfortable fit of the HMD 100 to a user's facial geometry. The at least partially flexible nature of the nose-bridge portion 116 enables minor alterations to be made to the geometry of the frame 110, after manufacturing and initial calibration, as a result of intentional or unintentional forces/stresses applied to the frame 110. These minor alterations to the frame 110 resulting from changes to the nose-bridge portion 116 may result in a misalignment of the left-eye virtual image 102A and the right-eye virtual image 102B which can be corrected via the system and method of calibration described above.

Conventional image light guides form a virtual image at optical infinity, conveying only collimated light to the eyebox E. In an example embodiment, the HMD 100 is configured to form the stereoscopic virtual image such that it appears to be focused at a finite distance, such as, for example, in the range from 1 m to 1.5 m or 2 m. Using near-focused solutions can allow the viewer to have the advantage of augmented reality imaging in applications where it is useful to have the real-world scene content at a close distance to the user. Changing binocular vergence that may induce the sensation of a change in focal depth of at least a portion of the virtual images produced can be achieved by moving the subset 570 of microLEDs 566 horizontally within the microLED array 560 and at least partially into the margin area of initially unused microLEDs 566 to alter the angular relationship of the image-bearing light conveyed through the image light guide systems 10A, 10B and change the alignment of the images 102A, 102B conveyed to the eyeboxes E and viewed by the user. This change in binocular vergence can be achieved utilizing the software suite as described above, with the user input device 160, incrementally shifting the position of the alignment points 602, 604 relative to the left-eye reticle 600A and the right-eye reticle 600B in the horizontal direction.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. A binocular augmented-reality display system, comprising:
a frame;
a first image light guide and a second image light guide supported by the frame;
a first image source system arranged within the frame, the first image source system comprising a first display panel having a first plurality of light sources;
a second image source system arranged within the frame, the second image source system comprising a second display panel having a second plurality of light sources;
at least one processor and at least one non-transitory computer-readable memory, wherein the processor and memory are arranged to execute and store, respectively, a set of non-transitory computer-readable instructions, that when executed by the processor are configured to:
generate, via the first image source system, a first image using a first subset of the first plurality of light sources;
receive a first input signal, and in response to the first input signal, generate a second image using a second subset of the first plurality of light sources; and
generate, via the second image source system, a third image using a first subset of the second plurality of light sources,
wherein the images generated by the first image source system are conveyed by the first image light guide to a first eyebox, and the images generated by the second image source system are conveyed by the second image light guide to a second eyebox, and
wherein the second image is stereoscopically aligned with the third image.

2. The binocular augmented-reality display system of claim 1, further comprising receiving a second input signal, and in response to the second input signal, generating a fourth image using a second subset of the second plurality of light sources.

3. The binocular augmented-reality display system of claim 1, wherein a first useable area of the first display panel operable to generate the first image is the same width and height as a second useable area of the first display panel operable to generate the second image.

4. The binocular augmented-reality display system of claim 1, wherein the frame includes an at least partially flexible nose-bridge portion.

5. The binocular augmented-reality display system of claim 3, wherein the first plurality of light sources comprises a subset of light sources unutilized to generate the second image.

6. The binocular augmented-reality display system of claim 1, further comprising a user input disposed on, in, or in proximity to the frame, wherein the first input signal is received via the user input.

7. The binocular augmented-reality display system of claim 1, wherein the first image is stereoscopically aligned with the third image at a first binocular vergence, and the second image is stereoscopically aligned with the third image at a second binocular vergence.

8. The binocular augmented-reality display system of claim 1, wherein the at least one processor and the at least one non-transitory computer-readable memory are located on at least one on-board chip of the first image source system and/or the second image source system.

9. The binocular augmented-reality display system of claim 8, further comprising a second processor configured to receive signals from one or more user inputs and transmit signals to the at least one processor located on the at least one on-board chip.

10. The binocular augmented-reality display system of claim 1, wherein the first image light guide and the second image light guide each comprise:
an in-coupling diffractive optic formed along the image light guide, wherein the in-coupling diffractive optic is operable to diffract at least a portion of the image-bearing light beams into the image light guide in an angularly encoded form; and
an out-coupling diffractive optic formed along the image light guide, wherein the out-coupling diffractive optic is operable to direct at least a portion of the image-bearing light beams from the image light guide in an angularly decoded form.

11. The binocular augmented-reality display system of claim 1, wherein the second subset of the first plurality of light sources is stored in the at least one non-transitory computer-readable memory, wherein the second subset of the first plurality of light sources it utilized to generate subsequent images.

12. A method of aligning images of a binocular augmented-reality display system, comprising:
providing a first image source system, the first image source system comprising a first display panel having a first plurality of light sources;
providing a second image source system, the second image source system comprising a second display panel having a second plurality of light sources;
providing at least one processor and at least one non-transitory computer-readable memory, wherein the processor and memory are arranged to execute and store, respectively, a set of non-transitory computer-readable instructions;
generating, via the first image source system, a first image using a first subset of the first plurality of light sources;
generating, via the second image source system, a second image using a first subset of the second plurality of light sources, wherein the second image is misaligned with the first image; and
receiving a first input signal, and in response to the first input signal, generating a third image using a second subset of the first plurality of light sources;
wherein the second image is aligned with the third image.

13. The method according to claim 12, wherein the first image comprises a first reticle and a first alignment point, wherein the second image comprises a second reticle and a second alignment point, wherein the third image comprises the first alignment point in a different position relative to the first reticle, and wherein the second reticle of the second image and the first reticle of the third image are aligned along an imaginary axis.

14. The method according to claim 12, wherein the first image comprises a first reticle and a first alignment point, wherein the second image comprises a second reticle and a second alignment point, and wherein the third image comprises the first alignment point in a different position relative to the first reticle, further comprising:
in response to the first input signal, generating a fourth image using a second subset of the second plurality of light sources, wherein the fourth image comprises the second alignment point in a different position relative to the second reticle;
wherein the second reticle of the fourth image and the first reticle of the third image are aligned along an imaginary axis.

15. The method according to claim 14, wherein the position of second reticle and the first reticle are adjusted simultaneously.

16. The method according to claim 12, further comprising a first image light guide and a second image light guide supported by a frame, wherein the first image source system and the second image source system are supported by the frame, and wherein the images generated by the first image source system are conveyed by the first image light guide to a first eyebox, and the images generated by the second image source system are conveyed by the second image light guide to a second eyebox.
